(19) United States
(12) Patent Application Publication
(10) Pub. No.: US 2020/0161790 A1
(43) Pub. Date: May 21, 2020

(54) ELECTRICAL CONNECTOR

(71) Applicant: LOTES CO., LTD., Keelung (TW)

(72) Inventor: Quan Long, Keelung (TW)

(21) Appl. No.: 16/669,961

(22) Filed: Oct. 31, 2019

(30) Foreign Application Priority Data
Nov. 19, 2018 (CN) 201811375309.3

(51) Int. Cl. H01R 13/24; H01R 13/26; H01R 13/646

(52) U.S. Cl. CPC H01R 13/2442; H01R 2107/00; H01R 13/646; H01R 13/26

(57) ABSTRACT

An electrical connector is used to electrically connect a first mating component to a second mating component. The electrical connector includes an insulating body, and at least one differential signal pair provided in the insulating body, including a long signal terminal and a short signal terminal. A length and a thickness of the long signal terminal are respectively greater than a length and a thickness of the short signal terminal. The long signal terminal includes a first contact portion, a first conducting portion and a first bending portion connecting the first contact portion and the first conducting portion. The short signal terminal includes a second contact portion, a second conducting portion and a second bending portion connecting the second contact portion and the second conducting portion. The first and second contact portions simultaneously contact the first mating component. The first and second conducting portions simultaneously contact the second mating component.

### CROSS-REFERENCE TO RELATED PATENT APPLICATION

This non-provisional application claims priority to and the benefit of, pursuant to 35 U.S.C. § 119(a), patent application Serial No. CN201811375309.3 filed in China on Nov. 19, 2018. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to an electrical connector, and in particular to an electrical connector for transmitting high-frequency signals.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

With the development of science and technology nowadays, there are more types of electrical connectors, and the fields of applications thereof become more extensive. Therefore, the requirements for electrical connectors are getting higher, including high-frequency signal transmission and miniaturization design of electrical connectors. For this reason, in certain environments, electrical connectors need to be designed to be side-mounted to suit a particular environment.

A side-mounted electrical connector is used for electrically connecting an electronic card to a circuit board. The side-mounted electrical connector includes an insulating body and multiple conductive terminals accommodated in the insulating body, and the conductive terminals further include multiple pairs of differential signal terminals. Since the insulating body is side-mounted, the conductive terminals are correspondingly designed in a track line-shaped arrangement such that the front ends of the conductive terminals are on a same vertical plane and contact the electronic card, soldering legs of the conductive terminals are on the same horizontal plane and connected to the circuit board, and the length of the conductive terminals is sequentially decreased inward from outside thereof. However, this arrangement causes the lengths of the two differential signal terminals of the same pair to be unequal. The differential signal terminal with a smaller length can transmit a signal to the electronic card or the circuit board more quickly than the differential signal terminal with a greater length when the signal is received at the same time, and the non-synchronously transmitted signals can easily cause signal distortion and ultimately affect high-frequency characteristics.

Therefore, a heretofore unaddressed need to design an improved electrical connector exists in the art to address the aforementioned deficiencies and inadequacies.

### SUMMARY

In view of the problems in the background, the present invention is directed to an electrical connector for transmitting high-frequency signals, which achieves the objectives of eliminating signal delay difference, ensuring signal synchronization and improving high-frequency characteristics by setting a thickness of the long signal terminal in the same differential signal pair to be greater than a thickness of the short signal terminal or a width of the long signal terminal to be greater than a width of the short signal terminal.

In order to achieve the foregoing objective, the present invention adopts the following technical solutions:

An electrical connector is configured to electrically connect a first mating component to a second mating component. The electrical connector includes: an insulating body; and at least one differential signal pair provided in the insulating body, including a long signal terminal and a short signal terminal, wherein a length of the long signal terminal is greater than a length of the short signal terminal, a thickness of the long signal terminal is greater than a thickness of the short signal terminal, the long signal terminal includes a first contact portion, a first conducting portion and a first bending portion connecting the first contact portion and the first conducting portion, the short signal terminal includes a second contact portion, a second conducting portion and a second bending portion connecting the second contact portion and the second conducting portion, the first contact portion and the second contact portion simultaneously contact the first mating component, and the first conducting portion and the second conducting portion simultaneously contact the second mating component.

In certain embodiments, a length of the first bending portion is greater than a length of the second bending portion, and a thickness of the first bending portion is greater than a thickness of the second bending portion.

In certain embodiments, the first bending portion further comprises a first connecting portion and a first extending portion bending and extending from the first connecting portion, the first connecting portion extends horizontally backward from the first contact portion, the first extending portion is connected with the first conducting portion, and a thickness of the first connecting portion is equal to a thickness of the first extending portion; and the second bending portion further comprises a second connecting portion and a second extending portion bending and extending from the second connecting portion, the second connecting portion extends horizontally backward from the second contact portion, the second extending portion is connected with the second conducting portion, and a thickness of the second connecting portion is equal to a thickness of the second extending portion.

In certain embodiments, the first bending portion comprises two first plate surfaces provided opposite to each other and two first cutting surfaces connecting the two first plate surfaces, a distance between the two first plate surfaces is the thickness of the first bending portion, a distance between the two first cutting surfaces is a width of the first bending portion, the distance between the two first plate surfaces at any position of the first bending portion is identical, and the distance between the two first cutting surfaces at any position of the first bending portion is identical; and the second bending portion comprises two second plate surfaces disposed opposite to each other and two second cutting surfaces connecting the two second plate surfaces, a distance between the two second plate surfaces is the thickness of the second bending portion, a distance between the two second cutting surfaces is a width of the second bending portion, the distance between the two second plate surfaces at any position of the second bending portion is identical, and the distance between the two second cutting surfaces at any position of the second bending portion is identical.

In certain embodiments, the first contact portion is parallel to the second contact portion, the first connecting portion is parallel to the second connecting portion, the first extending portion is parallel to the second extending portion, and the first conducting portion is parallel to the second conducting portion.

In certain embodiments, the long signal terminal further comprises a conductive terminal and a supplemental conductor, the supplemental conductor is superposed on the conductive terminal, the conductive terminal is sequentially provided with the first contact portion, a connecting part, an extending part and the first conducting portion, the supplemental conductor is sequentially provided with a supplemental connecting portion and a supplemental extending portion, the connecting part and the supplemental connecting portion jointly form the first connecting portion, and the extending part and the supplemental extending portion jointly form the first extending portion.

In certain embodiments, the electrical connector includes a plurality of differential signal pairs and a plurality of ground terminals, wherein the plurality of differential signal pairs and the ground terminals are alternately arranged in a row inward from outside thereof, lengths of the conductive terminals and the supplemental conductors of the differential signal pairs gradually decrease from inward from outside thereof, the lengths of the short signal terminals of the differential signal pairs gradually decrease inward from outside thereof, and lengths of the ground terminals gradually decrease inward from outside thereof.

In certain embodiments, the insulating body is provided with a protruding portion between the first connecting portion and the second connecting portion, and the protruding portion protrudes from the connecting part and the second connecting portion to be flush with the supplemental conductor.

In certain embodiments, a width of the long signal terminal is greater than a width of the short signal terminal.

An electrical connector is configured to electrically connect a first mating component to a second mating component. The electrical connector includes: an insulating body; and at least one differential signal pair provided in the insulating body, including a long signal terminal and a short signal terminal, wherein a length of the long signal terminal is greater than a length of the short signal terminal, a width of the long signal terminal is greater than a width of the short signal terminal, the long signal terminal comprises a first contact portion, a first conducting portion and a first bending portion connecting the first contact portion and the first conducting portion, the short signal terminal comprises a second contact portion, a second conducting portion and a second bending portion connecting the second contact portion and the second conducting portion, the first contact portion and the second contact portion simultaneously contact the first mating component, and the first conducting portion and the second conducting portion simultaneously contact the second mating component.

In certain embodiments, a length of the first bending portion is greater than a length of the second bending portion, and a width of the first bending portion is greater than a width of the second bending portion.

In certain embodiments, the first bending portion further includes a first connecting portion extending horizontally backward from the first contact portion and a first extending portion bending laterally from the first connecting portion, and a width of the first connecting portion is equal to a width of the first extending portion; and the second bending portion further includes a second connecting portion extending horizontally backward from the second contact portion and a second extending portion bending laterally from the second connecting portion, and a width of the second connecting portion is equal to a width of the second extending portion.

In certain embodiments, the first bending portion comprises two first plate surfaces provided opposite to each other and two first cutting surfaces connecting the two first plate surfaces, a distance between the two first plate surfaces is the thickness of the first bending portion, a distance between the two first cutting surfaces is a width of the first bending portion, the distance between the two first plate surfaces at any position of the first bending portion is identical, and the distance between the two first cutting surfaces at any position of the first bending portion is identical; and the second bending portion comprises two second plate surfaces disposed opposite to each other and two second cutting surfaces connecting the two second plate surfaces, a distance between the two second plate surfaces is the thickness of the second bending portion, a distance between the two second cutting surfaces is a width of the second bending portion, the distance between the two second plate surfaces at any position of the second bending portion is identical, and the distance between the two second cutting surfaces at any position of the second bending portion is identical.

In certain embodiments, the first contact portion is parallel to the second contact portion, the first connecting portion is parallel to the second connecting portion, the first extending portion is parallel to the second extending portion, and the first conducting portion is parallel to the second conducting portion.

In certain embodiments, the electrical connector includes a plurality of differential signal pairs and a plurality of ground terminals, wherein the plurality of differential signal pairs and the ground terminals are alternately arranged in a row inward from outside thereof, the lengths of the long signal terminals gradually decrease inward from outside thereof, the lengths of the short signal terminals gradually decrease inward from outside thereof, and lengths of the ground terminals further gradually decrease inward from outside thereof.

Compared with the related art, the electrical connector according to certain embodiments of the present invention have the following beneficial effects. In the same differential signal pair, the length of the long signal terminal is greater than the length of the short signal terminal, and the length difference between the long signal terminal and the short signal terminal is compensated for by setting the thickness of the long signal terminal to be greater than the thickness of the short signal terminal or setting the width of the long signal terminal to be larger than the width of the short signal terminal, so that the long signal terminal and the short signal terminal can simultaneously transmit signals to the circuit board while simultaneously receiving signals of the electronic card, so as to ensure that the transmitted signals are synchronous without causing signal distortion, thereby ensuring the high-frequency characteristics of the electrical connector.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective schematic view of an electrical connector, an electronic card and a circuit board according to a first embodiment of the present invention.

FIG. 2 is a perspective exploded view of the electrical connector in FIG. 1.

FIG. 3 is a perspective exploded view of an upper body in FIG. 2.

FIG. 4 is a partial sectional view of an upper body, a shielding sheet and a lower body in FIG. 2 after assembly.

FIG. 5 is a sectional view of FIG. 4 along line A-A.

FIG. 6 is a front view of FIG. 4.

FIG. 7 is an enlarged view of a portion a in FIG. 6.

FIG. 8 is a perspective exploded view of an upper body of an electrical connector according to a second embodiment of the present invention.

FIG. 9 is a front view of the upper body, a shielding sheet and a lower body in FIG. 8 after assembly.

FIG. 10 is an enlarged view of a portion b in FIG. 9.

FIG. 11 is a front view of an upper body, a shielding sheet and a lower body in an electrical connector according to a third embodiment of the present invention after assembly.

FIG. 12 is an enlarged view of a portion c in FIG. 11.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

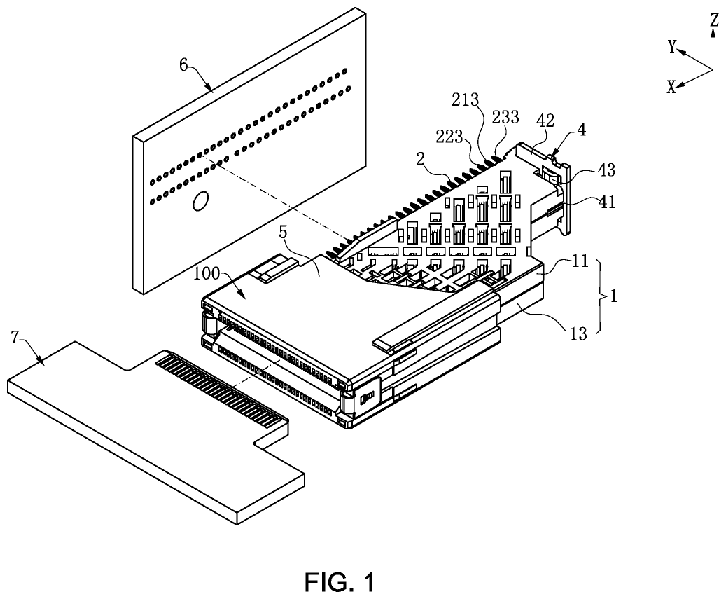

The description will be made as to the embodiments of the present invention in conjunction with the accompanying drawings in FIGS. 1-12. In accordance with the purposes of this invention, as embodied and broadly described herein, this invention, in one aspect, relates to an electrical connector.

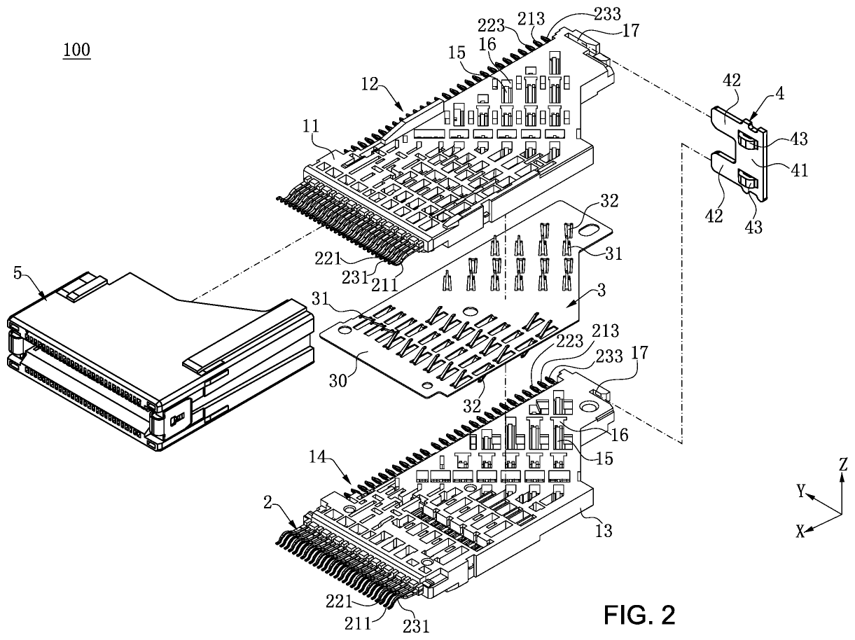

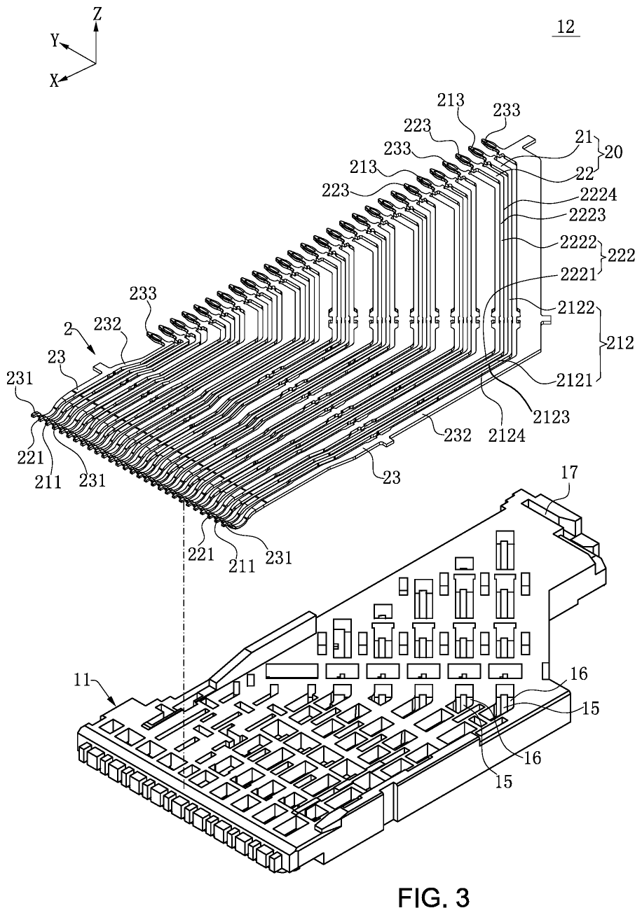

As shown in FIG. 1, FIG. 2 and FIG. 3, the electrical connector 100 according to a first embodiment of the present invention defines a front-rear direction X, a left-right direction Y and a vertical direction Z which are perpendicular to one another, where the rightward and backward directions are outward directions, and the leftward and frontward directions are inward directions. The electrical connector 100 includes an insulating body 1, conductive terminals 2 in an upper row and a lower row, a shielding sheet 3, a positioning member 4 and a shell 5, and each row of the conductive terminals 2 further include a plurality of differential signal pairs 20 and a plurality of ground terminals 23. The electrical connector 100 is used for electrically connecting a first mating component to a second mating component. In this embodiment, the first mating component is an electronic card 7, and the second mating component is a circuit board 6. The electrical connector 100 is soldered to the circuit board 6, the electronic card 7 is inserted into the electrical connector 100, and the electronic card 7 and the circuit board 6 are electrically connected through the conductive terminals 2, such that signal transmission can be performed between the electronic card 7 and the circuit board 6.

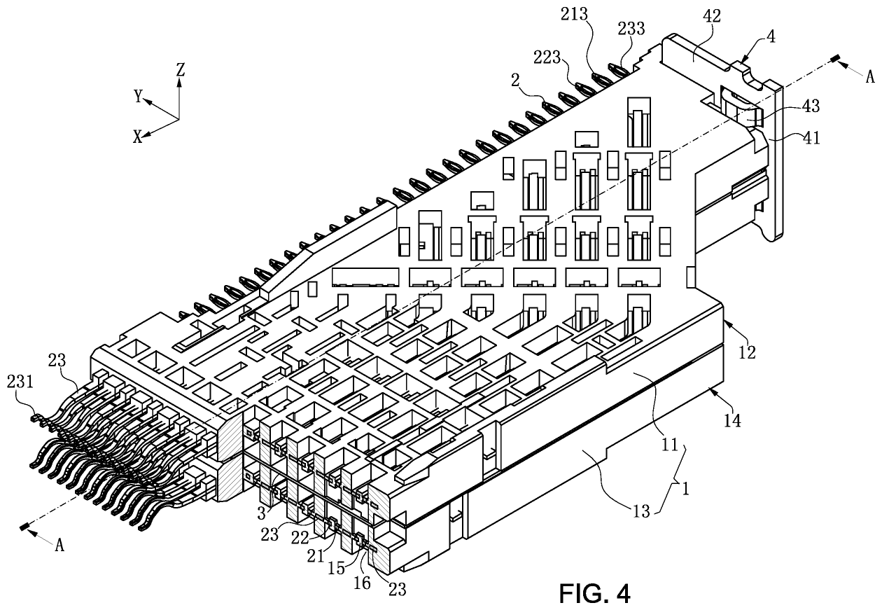

As shown in FIG. 2, FIG. 3 and FIG. 4, the insulating body 1 is formed by an upper body 11 and a lower body 13. The conductive terminals 2 in the upper row are insert-molded to the upper body 11 to form an upper module 12, and the conductive terminals 2 in the lower row are insert-molded to the lower body 13 to form a lower module 14. Each of the upper body 11 and the lower body 13 has a plurality of protruding portions 15, a plurality of grooves 16, and a clamping groove 17. Since the upper body 11 and the lower body 13 are identical, and the conductive terminals 2 in the upper row and the lower row are also identical, the upper module 12 and the lower module 14 are identical. Therefore, the upper module 12 is used as an example for explanation, while the lower module 14 is not further elaborated herein.

As shown in FIG. 3 and FIG. 4, in the conductive terminals 2 in the upper row, the ground terminals 23 and the differential signal pairs 20 are alternately arranged in the Y direction. The lengths of the conductive terminals 2 gradually decrease inward from outside thereof, and the length of the differential signal pair 20 on the inner side is smaller than the length of the ground terminal 23 on the outer side.

As shown in FIG. 2, FIG. 3 and FIG. 4, each of the differential signal pairs 20 further includes a long signal terminal 21 and a short signal terminal 22 provided adjacent to each other. The long signal terminal 21 is located on the outer side of the short signal terminal 22, and the length of the long signal terminal 21 is greater than the length of the short signal terminal 22. Each of the long signal terminals 21 sequentially includes a first contact portion 211, a first bending portion 212 and a first conducting portion 213 in the X direction backward from front thereof, and the first bending portion 212 further includes a first connecting portion 2121 extending horizontally backward from the first contact portion 211 and a first extending portion 2122 bending and extending from the first connecting portion 2121.

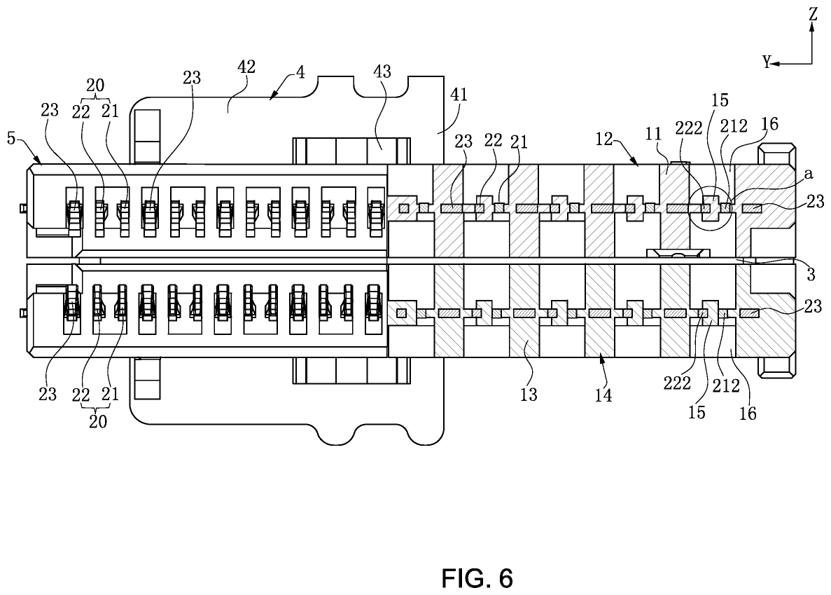

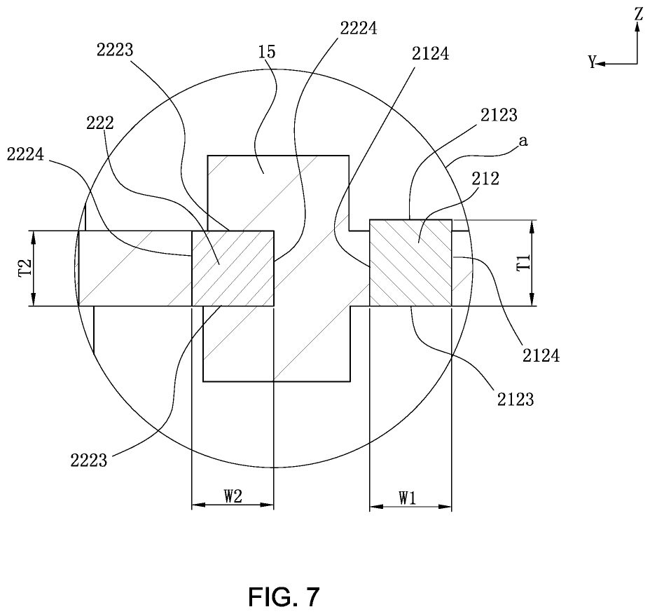

As shown in FIG. 2, FIG. 3 and FIG. 4, the first bending portion 212 includes two first plate surfaces 2123 provided opposite to each other in the Z direction and two first cutting surfaces 2124 connecting the two first plate surfaces. A distance between the two first plate surfaces 2123 is the thickness of the first bending portion 212, and a distance between the two first cutting surfaces 2124 is the width of the first bending portion 212. The distance between the two first plate surfaces 2123 at any position of the first bending portion 212 is identical, and the distance between the two first cutting surfaces 2124 at any position of the first bending portion 212 is also identical. That is, the width and thickness of each portion of the first bending portion 212 are identical, and the first bending portion 212 is uniform in size. Therefore, referring to FIG. 6 and FIG. 7, the thickness of each of the first connecting portion 2121 and the first extending portion 2122 is T1, and T1 is greater than the thickness of the first contact portion 211 and the thickness of the first conducting portion 213. The width of each of the first connecting portion 2121 and the first extending portion 2122 is W1.

As shown in FIG. 2, FIG. 3 and FIG. 4, each of the short signal terminals 22 sequentially includes a second contact portion 221, a second bending portion 222 and a second conducting portion 223 in the X direction backward from front thereof. The first contact portion 211 and the second contact portion 221 have the same thickness, and the first conducting portion 213 and the second conducting portion 223 have the same thickness. The second bending portion 222 further includes a second connecting portion 2221 extending horizontally backward from the second contact portion 221 and a second extending portion 2222 bending and extending from the second connecting portion 2221. The second bending portion 222 includes two second plate surfaces 2223 provided opposite to each other in the Z direction and two second cutting surfaces 2224 connecting the two second plate surfaces. A distance between the two second plate surfaces 2223 is the thickness of the second bending portion 222, and a distance between the two second cutting surfaces 2224 is the width of the second bending portion 222. The distance between the two second plate surfaces 2223 at any position of the second bending portion 222 is identical, and the distance between the two second cutting surfaces 2224 at any position of the second bending portion 222 is also identical. That is, the width and thickness of each portion of the second bending portion 222 are identical, and the second bending portion 222 is uniform in size. Therefore, referring to FIG. 6 and FIG. 7, the thickness of each of the second connecting portion 2221 and the second extending portion 2222 is T2, and T2 is greater than the thickness of the second contact portion 221 and the thickness of the second conducting portion 223. The width of each of the second connecting portion 2221 and the second extending portion 2222 is W2.

As shown in FIG. 1, FIG. 3 and FIG. 7, in the same differential signal pair 20, the length of the first bending portion 212 is greater than the length of the second bending portion 222. That is, the length of the long signal terminal 21 is greater than the length of the short signal terminal 22, and W1 is equal to W2. Therefore, by setting T1 to be greater than T2 in the long signal terminal 21, the length difference between the long signal terminal 21 and the short signal terminal 22 is compensated, such that the long signal terminal 21 and the short signal terminal 22 can simultaneously transmit signals to the circuit board 6 while simultaneously receiving signals of the electronic card 7, so as to ensure that the transmitted signals are synchronous without causing signal distortion, thereby ensuring the high-frequency characteristics of the electrical connector 100.

As shown in FIG. 2, FIG. 3 and FIG. 4, each of the ground terminals 23 sequentially includes a third contact portion 231, a third bending portion 232 and a third conducting portion 233 in the X direction backward from front thereof. A length of the third bending portion 232 on the outer side is greater than the length of the first bending portion 212 and the length of the second bending portion 222, the thickness of the third bending portion 232 is equal to T2, and the width of the third bending portion 232 is greater than W1 and W2, referring to FIG. 6. The first contact portion 211, the second contact portion 221 and the third contact portion 231 are in parallel, and all extend out of the front surface of the upper body 11 and are arranged in a row in the Y direction. The first bending portion 212, the second bending portion 222 and the third bending portion 232 are in parallel and commonly fixed in the upper body 11. The first conducting portion 213, the second conducting portion 223 and the third conducting portion 233 are in parallel, and all extend out of the left side surface of the upper body 11 and are arranged in a row in the X direction to be soldered to the circuit board 6.

As shown in FIG. 3, FIG. 4 and FIG. 6, in the upper module 12, the grooves 16 are provided at positions corresponding to the first bending portion 212 and the second bending portion 222, such that a portion of surfaces of the first bending portion 212 and the second bending portion 222 are exposed to the air, thereby achieving the purpose of adjusting crosstalk and impedance matching between the same differential signal pair 20. The protruding portions 15 are located in the groove 16 and are located between the first bending portion 212 and the second bending portion 222. The protruding portions 15 protrude from the upper surfaces of the first bending portion 212 and the second bending portion 222, and the protruding portions 15 partially cover the second bending portion 222 to block a magnetic field due to crosstalk generated between the long signal terminal 21 and the short signal terminal 22, thereby improving the crosstalk problem.

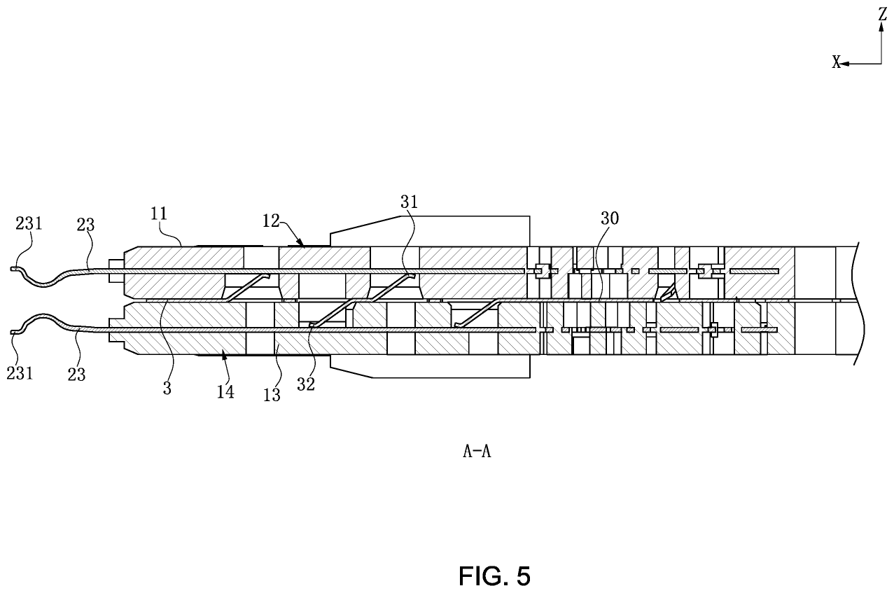

As shown in FIG. 2 and FIG. 5, the shielding sheet 3 is sandwiched between the upper module 12 and the lower module 14. The shielding sheet 3 includes a main body portion 30, a plurality of upper elastic sheets 31 extending upward from the main body portion 30, and a plurality of lower elastic sheets 32 extending downward. The upper elastic sheets 31 and the lower elastic sheets 32 are alternately arranged in the X direction. The upper elastic sheets 31 correspondingly contact the ground terminals 23 in the upper row, and the lower elastic sheets 32 correspondingly contact the ground terminals 23 in the lower row to achieve better shielding functions.

As shown in FIG. 2 and FIG. 4, the positioning member 4 includes a flat plate portion 41, two clamping arms 42 extending from a left side of the flat plate portion 41, and two protruding blocks 43 protruding from a front surface of the flat plate portion 41. After the upper body 11, the shielding sheet 3 and the lower body 13 are assembled together along the Z direction, the clamping arms 42 are inserted into the clamping groove 17, and the flat plate portion 41 is located at the right side of the upper body 11 and the lower body 13 to block the insulating body 1 from moving rightward in the Y direction. The protruding blocks 43 block the upper body 11 from moving upward in the Z direction and the lower body 13 from moving downward in the Z direction. The positioning member 4 clamps and fixes the upper body 11 and the lower body 13 together to prevent loosening.

As shown in FIG. 1, FIG. 2 and FIG. 3, the shell 5 is sleeved outside the upper module 12 and the lower module 14 such that the first contact portion 211 and the second contact portion 221 are accommodated in the shell 5. When the electronic card 7 is inserted into the shell 5, the electronic card 7 simultaneously contacts the first contact portions 211, the second contact portions 221 and the third contact portions 231 of the conductive terminals 2 in the upper row and the lower row, thereby achieving electrical connection.

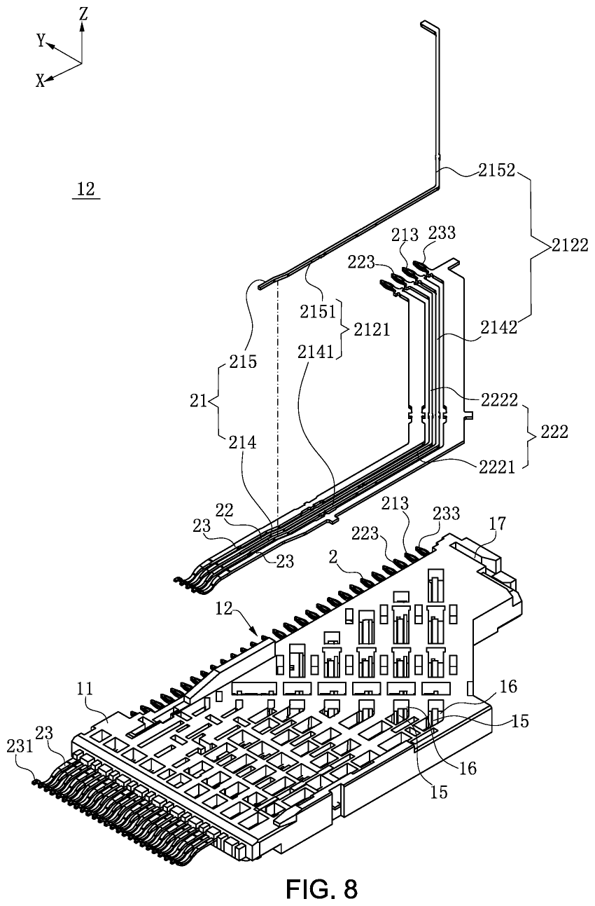

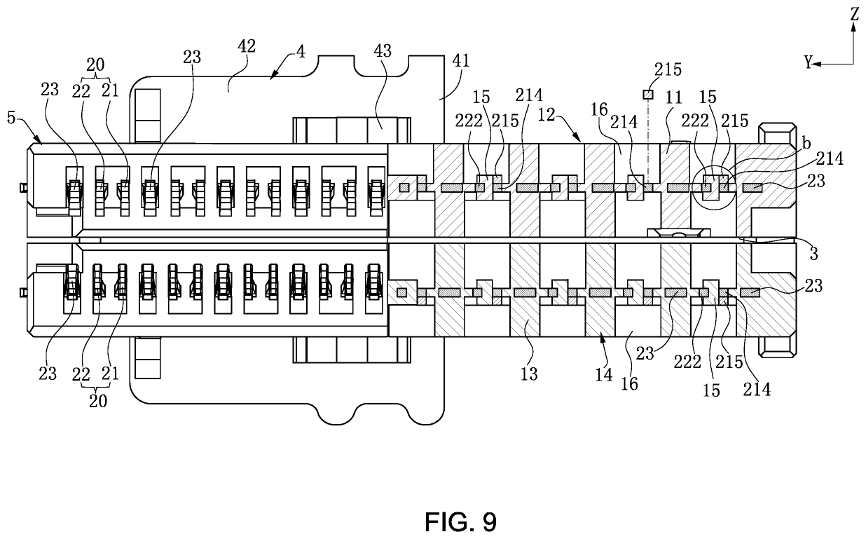

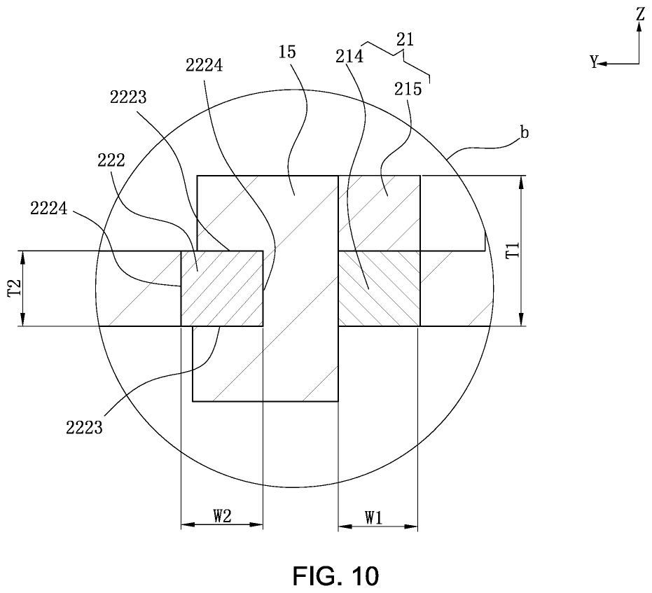

FIG. 8, FIG. 9 and FIG. 10 show a second embodiment of the present invention, which is different from the first embodiment in that: each of the long signal terminals 21 further includes a conductive terminal 214 and a supplemental conductor 215 superposed in the Z direction. In the conductive terminals 2 in the upper and lower rows, the lengths of the conductive terminals 214 and the supplemental conductors 215 gradually decrease inward from outside thereof. Each conductive terminal 214 is sequentially provided with the first contact portion 211, a connecting part 2141, an extending part 2142 and the first conducting portion 213 in the X direction backward from front thereof, and the connecting part 2141 and the extending part 2142 have the same thickness. Each supplemental conductor 215 is sequentially provided with a supplemental connecting portion 2151 and a supplemental extending portion 2152 having the same thickness in the X direction backward from front thereof. The connecting part 2141 and the supplemental connecting portion 2151 have the same shape and the same width of W1, and jointly form the first connecting portion 2121. The extending part 2142 and the additional extending portion 2152 have the same shape and the same width of W1, and jointly form the first extending portion 2122, where W1 is equal to W2. Since the thickness of each conductive terminal 214 is not greater than the thickness of each short signal terminal 22, the long signal terminal 21 achieves the objective of increasing the thickness by additionally providing the supplemental conductor 215 such that T1 is greater than T2.

The protruding portion 15 protrudes from the connecting part 2141 and the second connecting portion 2221 to be flush with the supplemental conductor 215, and the supplemental conductor 215 is closely attached to a side surface of the protruding portion 15.

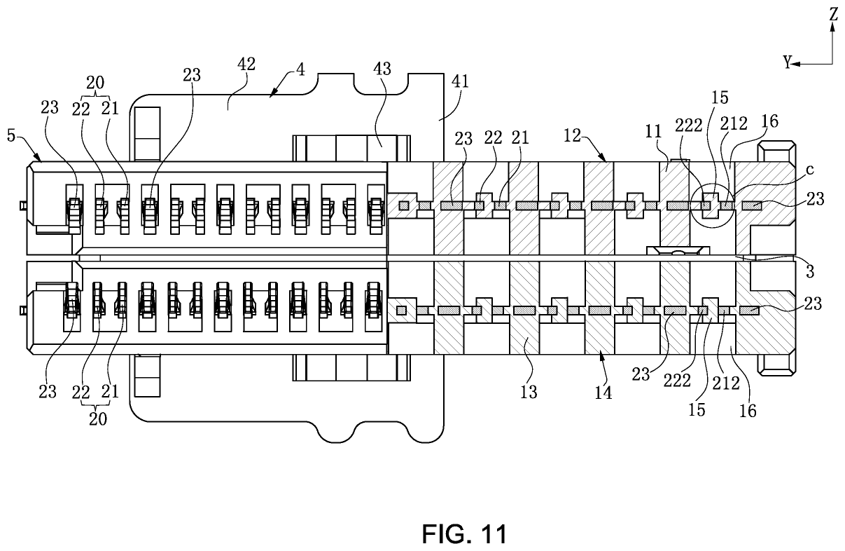

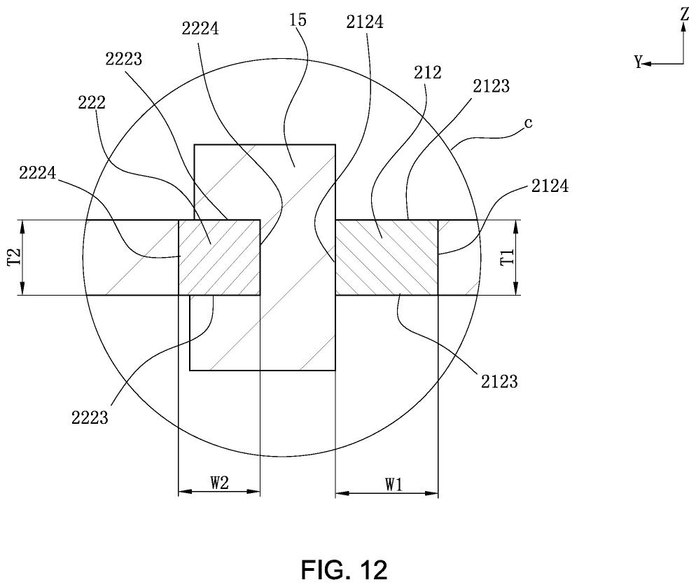

FIG. 11 and FIG. 12 show a third embodiment of the present invention, which is different from the first embodiment in that: T1 is equal to T2, the same differential signal pair 20 compensates for the length difference between the long signal terminal 21 and the short signal terminal 22 by setting W1 to be greater than W2, such that the long signal terminal 21 and the short signal terminal 22 can transmit signals synchronously. Of course, in addition to setting the width of the long signal terminal 21 to be greater than the width of the short signal terminal 22, in other embodiments, the long signal terminal 21 may further include the conductive terminal 214 and the supplemental conductor 215 closely attached to the left side or right side of the conductive terminal 214, and the width of the long signal terminal 21 is increased by additionally providing the supplemental conductor 215.

To sum up, the electrical connector 100 according to certain embodiments of the present invention has the following beneficial effects:

(1) In the same differential signal pair 20, the length of the long signal terminal 21 is greater than the length of the short signal terminal 22, and the length difference between the long signal terminal 21 and the short signal terminal 22 is compensated for by setting the thickness of the long signal terminal 21 to be greater than the thickness of the short signal terminal 22, such that the long signal terminal 21 and the short signal terminal 22 can simultaneously transmit signals to the circuit board 6 while simultaneously receiving signals of the electronic card 7, so as to ensure that the transmitted signals are synchronous without causing signal distortion, thereby ensuring the high-frequency characteristics of the electrical connector 100.

(2) The supplemental conductor 215 is superposed to the conductive terminal 214 to increase the thickness of the long signal terminal 21, and the impedance of the long signal terminal 21 can be adjusted by directly adjusting the size of the supplemental conductor 215 of the long signal terminal 21. Therefore, the impedance matching between the same differential signal pair 20 is more convenient and faster.

(3) In the same differential signal pair 20, the length of the long signal terminal 21 is greater than the length of the short signal terminal 22, and the length difference between the long signal terminal 21 and the short signal terminal 22 is compensated for by setting the width of the long signal terminal 21 to be greater than the width of the short signal terminal 22, such that the long signal terminal 21 and the short signal terminal 22 can simultaneously transmit signals to the circuit board 6 while simultaneously receiving signals of the electronic card 7, thereby eliminating the signal delay difference and ensuring the signal synchronization and the high-frequency characteristics of the electrical connector 100.

(4) The grooves 16 partially expose the surfaces of the first connecting portion 2121, the first extending portion 2122, the second connecting portion 2221 and the second extending portion 2222 in the air, thereby achieving the objective of adjusting the crosstalk and impedance matching between the same differential signal pair 20.

(5) The protruding portions 15 are located in the grooves 16 and are located between the first bending portion 212 and the second bending portion 222 to block the a magnetic field due to crosstalk generated between the long signal terminal 21 and the short signal terminal 22, thereby improving the crosstalk problem. The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, configured to electrically connect a first mating component to a second mating component, the electrical connector comprising:
an insulating body; and
at least one differential signal pair provided in the insulating body, comprising a long signal terminal and a short signal terminal, wherein a length of the long signal terminal is greater than a length of the short signal terminal, a thickness of the long signal terminal is greater than a thickness of the short signal terminal, the long signal terminal comprises a first contact portion, a first conducting portion and a first bending portion connecting the first contact portion and the first conducting portion, the short signal terminal comprises a second contact portion, a second conducting portion and a second bending portion connecting the second contact portion and the second conducting portion, the first contact portion and the second contact portion simultaneously contact the first mating component, and the first conducting portion and the second conducting portion simultaneously contact the second mating component.

2. The electrical connector according to claim 1, wherein a length of the first bending portion is greater than a length of the second bending portion, and a thickness of the first bending portion is greater than a thickness of the second bending portion.

3. The electrical connector according to claim 2, wherein:
the first bending portion further comprises a first connecting portion and a first extending portion bending and extending from the first connecting portion, the first connecting portion extends horizontally backward from the first contact portion, the first extending portion is connected with the first conducting portion, and a thickness of the first connecting portion is equal to a thickness of the first extending portion; and
the second bending portion further comprises a second connecting portion and a second extending portion bending and extending from the second connecting portion, the second connecting portion extends horizontally backward from the second contact portion, the second extending portion is connected with the second conducting portion, and a thickness of the second connecting portion is equal to a thickness of the second extending portion.

4. The electrical connector according to claim 3, wherein:
the first bending portion comprises two first plate surfaces provided opposite to each other and two first cutting surfaces connecting the two first plate surfaces, a distance between the two first plate surfaces is the thickness of the first bending portion, a distance between the two first cutting surfaces is a width of the first bending portion, the distance between the two first plate surfaces at any position of the first bending portion is identical, and the distance between the two first cutting surfaces at any position of the first bending portion is identical; and
the second bending portion comprises two second plate surfaces disposed opposite to each other and two second cutting surfaces connecting the two second plate surfaces, a distance between the two second plate surfaces is the thickness of the second bending portion, a distance between the two second cutting surfaces is a width of the second bending portion, the distance between the two second plate surfaces at any position of the second bending portion is identical, and the distance between the two second cutting surfaces at any position of the second bending portion is identical.

5. The electrical connector according to claim 3, wherein the first contact portion is parallel to the second contact portion, the first connecting portion is parallel to the second connecting portion, the first extending portion is parallel to the second extending portion, and the first conducting portion is parallel to the second conducting portion.

6. The electrical connector according to claim 3, wherein the long signal terminal further comprises a conductive terminal and a supplemental conductor, the supplemental conductor is superposed on the conductive terminal, the conductive terminal is sequentially provided with the first contact portion, a connecting part, an extending part and the first conducting portion, the supplemental conductor is sequentially provided with a supplemental connecting portion and a supplemental extending portion, the connecting part and the supplemental connecting portion jointly form the first connecting portion, and the extending part and the supplemental extending portion jointly form the first extending portion.

7. The electrical connector according to claim 6, comprising a plurality of differential signal pairs and a plurality of ground terminals, wherein the plurality of differential signal pairs and the ground terminals are alternately arranged in a row inward from outside thereof, lengths of the conductive terminals and the supplemental conductors of the differential signal pairs gradually decrease from inward from outside thereof, the lengths of the short signal terminals of the differential signal pairs gradually decrease inward from outside thereof, and lengths of the ground terminals gradually decrease inward from outside thereof

8. The electrical connector according to claim 6, wherein the insulating body is provided with a protruding portion between the first connecting portion and the second connecting portion, and the protruding portion protrudes from the connecting part and the second connecting portion to be flush with the supplemental conductor.

9. The electrical connector according to claim 1, wherein a width of the long signal terminal is greater than a width of the short signal terminal.

10. An electrical connector, configured to electrically connect a first mating component to a second mating component, the electrical connector comprising:
an insulating body; and
at least one differential signal pair provided in the insulating body, comprising a long signal terminal and a short signal terminal, wherein a length of the long signal terminal is greater than a length of the short signal terminal, a width of the long signal terminal is greater than a width of the short signal terminal, the long signal terminal comprises a first contact portion, a first conducting portion and a first bending portion connecting the first contact portion and the first conducting portion, the short signal terminal comprises a second contact portion, a second conducting portion and a second bending portion connecting the second contact portion and the second conducting portion, the first contact portion and the second contact portion simultaneously contact the first mating component, and the first conducting portion and the second conducting portion simultaneously contact the second mating component.

11. The electrical connector according to claim 10, wherein a length of the first bending portion is greater than a length of the second bending portion, and a width of the first bending portion is greater than a width of the second bending portion.

12. The electrical connector according to claim 11, wherein:
the first bending portion further comprises a first connecting portion extending horizontally backward from the first contact portion and a first extending portion bending laterally from the first connecting portion, and a width of the first connecting portion is equal to a width of the first extending portion; and
the second bending portion further comprises a second connecting portion extending horizontally backward from the second contact portion and a second extending portion bending laterally from the second connecting portion, and a width of the second connecting portion is equal to a width of the second extending portion.

13. The electrical connector according to claim 12, wherein:
the first bending portion comprises two first plate surfaces provided opposite to each other and two first cutting surfaces connecting the two first plate surfaces, a distance between the two first plate surfaces is the thickness of the first bending portion, a distance between the two first cutting surfaces is a width of the first bending portion, the distance between the two first plate surfaces at any position of the first bending portion is identical, and the distance between the two first cutting surfaces at any position of the first bending portion is identical; and
the second bending portion comprises two second plate surfaces disposed opposite to each other and two second cutting surfaces connecting the two second plate surfaces, a distance between the two second plate surfaces is the thickness of the second bending portion, a distance between the two second cutting surfaces is a width of the second bending portion, the distance between the two second plate surfaces at any position of the second bending portion is identical, and the distance between the two second cutting surfaces at any position of the second bending portion is identical.

14. The electrical connector according to claim 12, wherein the first contact portion is parallel to the second contact portion, the first connecting portion is parallel to the second connecting portion, the first extending portion is parallel to the second extending portion, and the first conducting portion is parallel to the second conducting portion.

15. The electrical connector according to claim 10, comprising a plurality of differential signal pairs and a plurality of ground terminals, wherein the plurality of differential signal pairs and the ground terminals are alternately arranged in a row inward from outside thereof, the lengths of the long signal terminals gradually decrease inward from outside thereof, the lengths of the short signal terminals gradually decrease inward from outside thereof, and lengths of the ground terminals further gradually decrease inward from outside thereof.
